(19) United States
(12) Patent Application Publication
(10) Pub. No.: US 2007/0133645 A1
(43) Pub. Date: Jun. 14, 2007

(54) Controlling the spatio-temporal uniformity of a pulsed gas laser beam

(76) Inventors: Maxime Makarov, Viroflay (FR); Marc Stehle, Meudon (FR)

Correspondence Address: CHRISTIE, PARKER & HALE, LLP, PO BOX 7068, PASADENA, CA, 91109-7068, US

(21) Appl. No.: 10/552,500

(22) PCT Filed: Mar. 9, 2004
(86) PCT No.: PCT/FR04/00557

§ 371 Date: Jul. 17, 2006

(30) Foreign Application Priority Data
Apr. 8, 2003 (FR) 03/04355

(51) Int. Cl. H01S 3/22; H01S 3/097

(52) U.S. Cl. 372/87; 372/55

(57) ABSTRACT

The invention relates to the control of the spatio-temporal uniformity of a pulsed gas laser beam, especially generated by a high-power excimer laser. According to the invention, two raised lateral parts are provided on at least one of the discharge electrodes, said parts enabling the electrical discharge to be initialised at this level and to remain constantly stuck at this level after having spread over the entire surface of the electrode between said raised parts. In order to compensate for the lack of uniformity of the discharge created by the lack of uniformity of the electric field, the collimation mask of the preionisation X-rays is thinned from the edges thereof towards the centre thereof in order to progressively reinforce the preionisation from the outer level of the discharge to the centre of the same. The invention enables a discharge to be obtained, and thus a plasma, which are both spatially uniform and temporally stable. The laser beam obtained from said plasma is thus uniform and stable itself.

The present invention relates to controlling the spatio-temporal uniformity of a pulsed gas laser beam, more particularly of a large, high-strength laser of the excimer type.

In a laser of this type, a suitable gas is excited by a series of brief and repetitive electric discharges between two substantially planar electrodes in order to obtain a plasma which serves as an active medium for the laser. In order to promote and, to a certain extent, confine this discharge, an X-ray preionisation beam is used whose axis is substantially in alignment with that of the discharge. A laser pulse corresponds to each discharge. A description of a laser of this type can be found in particular in an article by H. Mizoguchi et al. entitled “Rapid Discharge-Pumped Wide Aperture X-ray Preionised KrF Laser” and published in Appl. Phys. B 52, pp 195-199 (1991).

The plasma obtained at each discharge is substantially unstable which significantly interferes with the corresponding laser pulse. The laser beam obtained in this manner therefore lacks both spatial and temporal uniformity.

In order to seek to obtain a plasma and therefore a laser beam which are uniform, it has been proposed that the profile of at least one of the electrodes be modified in order to make the electric field in the discharge as homogeneous as possible. The description of specific profiles which have been specially designed for this purpose can be found, for example, in the article by G. ERNST “Uniform-Field Electrodes With Minimum Width”, published in Opt. Commun 49(4), 275-277 (1984) or that by T. CHANG, “Improved Uniform-Field Electrode Profiles for TEA Laser and High-Voltage Applications”, published in Rev. Sci. Instrum., 44(4), 405-407 (1973). It has also been proposed that the X-ray beam be profiled by masking the peripheral portions of the discharge at locations where the electric field is generally heterogeneous or the plasma is subjected to interference by the skin effect. These methods are used in particular in the Mizoguchi laser mentioned above.

It is also known to use ancillary optical devices in order to correct some of the faults of the laser beam which is output from the laser head in the “raw” state. This supposes, however, that the heterogeneous properties of this beam are stable and repetitive and does not therefore overcome the problems presented by the temporal instabilities of the discharge.

Although it is well known how to obtain a relatively uniform initial electric field, as soon as the discharge is triggered, it interferes in a more or less random manner with the distribution of the field and therefore the homogeneity of the plasma obtained. Even when the profiling of the electrodes (for example, according to the methods described in the articles mentioned above) allows an initial electric field to be obtained which is as homogeneous as possible, the discharge has the tendency to contract towards the centre of the electrodes, which brings about a significant degradation of the laser pulse.

The X-ray preionisation beam only very partially allows this phenomenon to be overcome. Furthermore, in the configurations in which this beam is partially masked, the masks used must be replaced each time it is desirable to change the operating conditions of the laser, for example, in order to modify the variation of the energy emitted. This procedure takes a considerable length of time and correspondingly slows down the operational capacities of the laser.

In order to overcome these disadvantages, the invention proposes a method for controlling the spatio-temporal uniformity of a pulsed gas laser beam, in which a pulsed electric discharge is brought about in a gas between two electrodes and an X-ray preionisation beam is applied to this gas whose axis is substantially in alignment with that of the discharge, principally characterised in that a lateral intensification of the electric field is produced in the space between the electrodes in order to stabilise the discharge in time and space, and in that an axial intensification of the X-ray beam is produced in order to compensate for the modifications of the uniformity of the discharge resulting from this lateral intensification of the electric field.

The invention also proposes a laser for carrying out the above method, principally characterised in that it comprises at least one electrode which is profiled in order to comprise two raised lateral portions which allow the lateral intensification of the electric field to be obtained in this region.

According to another feature, the height of the raised lateral portions is substantially in the order of one hundredth of the distance between the two electrodes.

According to another feature, the two electrodes are profiled in order to obtain the lateral intensification of the electric field.

According to another feature, the laser comprises a progressive mask relative to the X-rays in order to progressively attenuate, from the centre of the discharge to the edges thereof, the X-ray preionisation beam applied along an axis which is substantially in alignment with that of the discharge in order to compensate for the lack of uniformity of the discharge resulting from the intensification of the electric field at the edges thereof.

According to another feature, the progressive mask is formed by a plate which absorbs the X-rays and whose thickness is reduced progressively from the locations opposite the two raised lateral portions where the absorption of the X-rays is at a maximum as far as a central portion where the absorption is substantially zero.

According to another feature, the progressive nature of the reduction in thickness of the plate which absorbs the X-rays allows the profile of the absorption curve of the X-rays to be adapted to the profile of the electric field between these two lateral intensifications.

According to another feature, the plate which absorbs the X-rays is reduced in thickness in accordance with two substantially linear ramps which extend from one of the surfaces thereof in the region of the edges of the discharge in order to open at the other surface, with a central hole being defined which corresponds to the maximum transmission.

According to another feature, the laser is of the excimer type.

Other features and advantages of the invention will be appreciated clearly from the following description, given with reference to the appended drawings, in which:

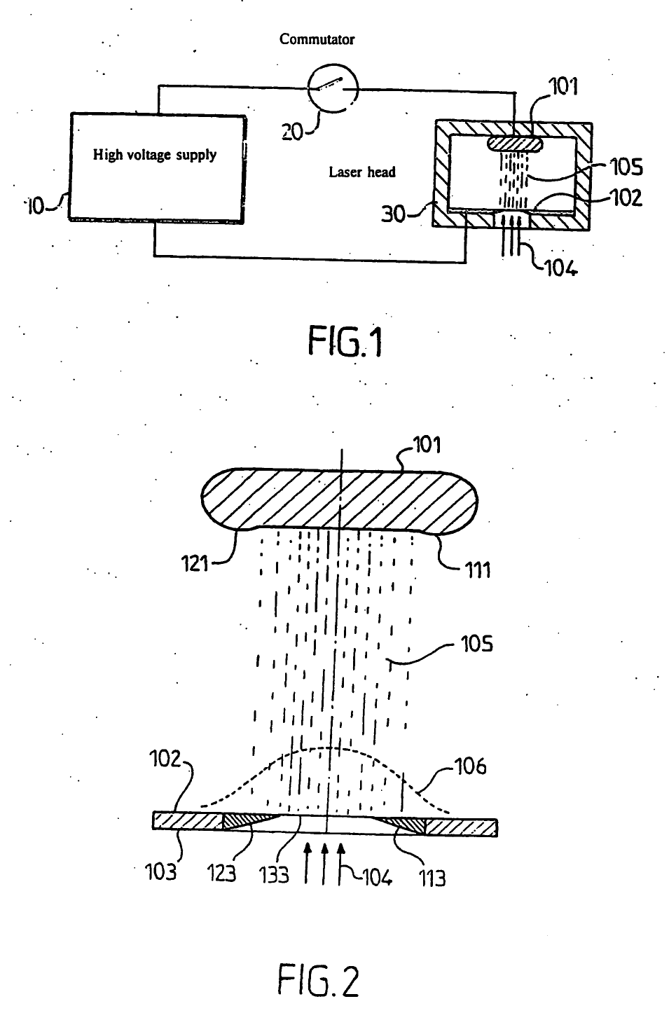

FIG. 1 is a block diagram of a laser comprising a head according to the invention; and

FIG. 2 is a sectioned illustration of the significant elements of the laser head illustrated in FIG. 1.

The construction of pulsed gas lasers of the type according to the invention is very well known in the art and is clearly set out in detail in a number of articles, such as that by Mizoguchi mentioned above in this description.

A laser of this type is therefore composed, as illustrated in FIG. 1, of three main sub-systems: a high-voltage supply 10, a commutator 20 and a laser head 30 in which the electric discharge develops. The supply 10 allows a sufficient quantity of energy to be accumulated to obtain the desired discharge. When sufficient energy has been accumulated, the commutator 20 connects the supply to the laser head, which brings about the discharge. This electric discharge allows a flash of ultra-violet light to be obtained which is emitted from the laser cavity.

Only the elements which have been modified according to the invention will be illustrated and described in the remainder of this description.

The laser head according to the invention which is illustrated in detail in FIG. 2 comprises a profiled electrode 101 and a planar electrode 102, between which a pulsed electric discharge develops which forms a plasma 105.

An X-ray beam 104 which extends along the longitudinal axis of the device is introduced into the space between the electrodes by means of a progressive mask 103 which is produced from a material which absorbs these X-rays, for example, copper. In this embodiment, this mask is placed below and in contact with the electrode 102 but the position thereof could be different provided that it brings about the desired effect described below.

In the constructions which are known and widely used in the art, the profile of the electrodes is examined in order to obtain an electric field which is as homogeneous as possible, as described in the above-mentioned articles.

The invention proposes that this basic profile be modified in order to produce an electrode 101 which is profiled so as to comprise two raised lateral portions 111 and 121. To this end, it is possible to use, for example, the calculation method proposed by E. A. STAPPAERTS in Appl. Phys. Lett 40(12) of 15^{th} June 1982, p. 1018 and 1019. Two raised lateral portions allow the electric field to be intensified locally. Under the action of this local intensification, the electric discharge is initialised in the region of these raised lateral portions and remains constantly captured at that location after it has extended to the entire surface of the electrode between these raised lateral portions, for the entire duration of the discharge pulse. The width of the discharge is therefore determined only by the distance between the raised lateral portions 111 and 121. This width does not change for the entire duration of the pulse and the space between these raised lateral portions is completely filled by the discharge.

In a preferred construction of the invention, the height of the raised portions of these lateral portions relative to the central portion of the electrode 101 is in the order of one hundredth of the distance between the electrodes 101 and 102.

The embodiment described in this manner does not limit the invention and any other profiling of the electrodes which allows such a local lateral intensification of the electric field to be obtained which has the effect of initially capturing and maintaining the electric discharge and filling the entire space between these lateral intensifications with the pulse for the entire duration of the pulse is included within the scope of the invention. In particular, it would be possible to have specific profiling of the two electrodes.

However, since the intensity of the discharge is particularly sensitive to the value of the electric field, this local intensification of the electric field brings about a degradation of the uniformity of the discharge. The intensity thereof is therefore reduced closer to the centre of the electrodes, but still remains stable.

According to the invention, this negative effect is compensated for by strengthening the intensity of the X-ray preionisation beam 104 progressively from the outer region of the discharge that is determined by the raised portions 111 and 121 as far as the centre of this discharge.

To this end, the substantially planar plate which forms the collimation mask 103 of the X-ray beam is reduced in thickness by bevelling from the outer side towards the centre so as to have an X-ray transmission which is substantially zero at the outer region of the discharge and a maximum transmission in the region of the longitudinal axis thereof. In the Figures, this reduction in thickness is illustrated schematically by two substantially linear ramps 113 and 123 which extend from the lower surface of the mask in order to open at the upper surface thereof, with a central hole 133 being defined which corresponds to the maximum transmission. In the embodiment described in this instance, the compensation is not complete but is sufficient for a large number of the examples encountered in practice. In order to provide better compensation, the precise profile of this reduction in thickness is determined to correspond precisely to the variation of the electric field between the two raised portions 111 and 121.

The effect of this progressive mask is to determine a lateral variation in the intensity of the X-ray beam which is illustrated in the Figures purely by way of illustration by the curve 106 which is roughly in the shape of a bell. When the narrowed profile of the mask is well adapted to the shape of the electrode 101, this curve 106 itself illustrates inversely the variation of the electric field from one edge of the discharge to the other.

The effects of the variation of the electric field and the intensity of the X-ray beam therefore compensate for each other in order to allow a discharge, and therefore a plasma, to be obtained which are homogeneous in terms of space and time between the two electrodes.

This plasma therefore retains constant dimensions and homogeneity for the entire duration of the pulse which gives rise to it. The laser beam which is obtained by means of stimulated emission from this same plasma is therefore. homogeneous and has a constant shape for the entire duration of the pulse.

Furthermore, the shape of the laser beam itself remains constant regardless of the modifications to the operating conditions of the laser, in particular, the variations of energy produced by modifying the supply parameters of the discharge electrodes. This also allows the efficiency of the known optical devices for correcting the laser beam to be kept constant, regardless of the operating conditions of the laser.

1. Method for controlling the spatio-temporal uniformity of a pulsed gas laser beam, in which a pulsed electric discharge is brought about in a gas between two electrodes (101, 102) and an X-ray preionisation beam (104) is applied to this gas whose axis is substantially in alignment with that of the discharge, characterised in that a lateral intensification of the electric field is produced in the space between the electrodes in order to stabilise the discharge in time and space, and in that an axial intensification of the X-ray beam is produced in order to compensate for the modifications of the uniformity of the discharge resulting from this lateral intensification of the electric field.

2. Laser for carrying out the method according to claim 1, characterised in that it comprises at least one electrode (101) which is profiled in order to comprise two raised lateral portions (111, 121) which allow the lateral intensification of the electric field to be obtained in this region.

3. Laser according to claim 2, characterised in that the height of the raised lateral portions (111, 121) is substantially in the order of one hundredth of the distance between the two electrodes (101, 102).

4. Laser according to either claim 2 or claim 3, characterised in that the two electrodes (101, 102) are profiled in order to obtain the lateral intensification of the electric field.

5. Laser according to claim 2, characterised in that it comprises a progressive mask (103) relative to the X-rays in order to progressively attenuate, from the centre of the discharge to the edges thereof, the X-ray preionisation beam applied along an axis which is substantially in alignment with that of the discharge in order to compensate for the lack of uniformity of the discharge resulting from the intensification of the electric field at the edges thereof.

6. Laser according to claim 5, characterised in that the progressive mask (103) is formed by a plate which absorbs the X-rays and whose thickness is reduced progressively from the locations opposite the two raised lateral portions (111, 121) where the absorption of the X-rays is at a maximum as far as a central portion where the absorption is substantially zero.

7. Laser according to either claim 5, or claim 6, characterised in that the progressive nature of the reduction in thickness of the plate (103) which absorbs the X-rays allows the profile of the absorption curve (106) of the X-rays to be adapted to the profile of the variation of the electric field between these two lateral intensifications.

8. Laser according to either claim 5 or claim 6, characterised in that the plate (103) which absorbs the X-rays is reduced in thickness in accordance with two substantially linear ramps (113, 123) which extend from one of the surfaces thereof in the region of the edges of the discharge in order to open at the other surface, with a central hole (133) being defined which corresponds to the maximum transmission.

9. Laser according to claim 2, characterised in that it is of the excimer type.
